(19) United States
(12) Patent Application Publication
(10) Pub. No.: US 2015/0220690 A1
(43) Pub. Date: Aug. 6, 2015

(54) SYSTEMS AND METHODS FOR DETERMINING AND COMMUNICATING A BENEFIT RESPONSE MESSAGE

(71) Applicant: MCKESSON FINANCIAL HOLDINGS, Hamilton (BM)

(72) Inventor: Summerpal Kahlon, Satellite Beach, FL (US)

(73) Assignee: MCKESSON FINANCIAL HOLDINGS, Hamilton (BM)

(21) Appl. No.: 14/173,200

(22) Filed: Feb. 5, 2014

(51) Int. Cl. G06F 19/00

(52) U.S. Cl. CPC G06F 19/328

(57) ABSTRACT

Systems and methods are provided for determining and communicating a benefit response message corresponding to a benefit contract status. The benefit contract status may be based upon a benefit group identifier included in a healthcare transaction. The healthcare transaction may be received by the service provider computer from a healthcare provider computer. The healthcare transaction may include prescription transaction information. The service provider may utilize the prescription transaction information to determine a benefit group identifier. The service provider may determine a contract status of the benefit group associated with the benefit response message. The service provider may transmit a provider or a limited provider message to the healthcare provider computer based upon the determination of the contract status of the benefit group.

### TECHNICAL FIELD

Aspects of the disclosure relate generally to determining and communicating a benefits response message and more particularly, to systems and methods for determining and communicating a benefit response message corresponding to a benefit group contract status.

### BACKGROUND

Today, the National Council for Prescription Drug Programs (NCPDP) Telecommunications standard is often used to communicate drug cost information between Pharmacy Benefit Managers (PBM) and pharmacies. The healthcare provider is generally not included in the communication. At times, without drug cost information, a healthcare provider may not choose to prescribe a certain medication. Furthermore, the (NCPDP) Telecommunications standard supports an additional field that may be utilized to communicate additional information, other that drug cost information to eligible pharmacies and/or healthcare providers. However, designating which pharmacies and/or healthcare providers are eligible to view any additional information contained in the additional information field(s) has limited their use by PBMs.

### BRIEF DESCRIPTION OF THE DRAWINGS

Reference will now be made to the accompanying drawings, which are not necessarily drawn to scale, and wherein:

FIG. 1 illustrates an example system for facilitating, among other things, determining and communicating a benefits response message, according to one exemplary embodiment.

FIG. 2 is a block diagram for receiving and communicating a healthcare transaction, according to one exemplary embodiment.

FIG. 3 illustrates a flow chart of an example method for receiving and communicating a healthcare transaction, according to one exemplary embodiment.

FIG. 4 is a block diagram for determining the status of a benefits group, according to one exemplary embodiment.

FIG. 5 is a block diagram for generating a benefits response message, according to one exemplary embodiment.

FIG. 6 illustrates a flow chart of an example method for generating a benefits response message, according to one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate determining and communicating a benefits response message. In some example implementations, the benefits response message may be communicated in response to an adjudicated or pre-adjudicated healthcare transaction communicated from a healthcare provider. In some examples, the benefits response message may be communicated in real time or near real time to a service provider. The service provider may route the healthcare transaction to an appropriate healthcare benefits provider or pharmacy benefits provider for processing. In one example, the appropriate healthcare benefits provider may be determined using information included in the healthcare transaction. For example, the healthcare transaction may include a patient name, a patient identification number, a visit date, a healthcare facility identification, a healthcare facility name, a healthcare facility location, a healthcare benefits group name, a healthcare benefits group number, a medication name, a medication identification number, a physician name, a physician identification number, or the like. The service provider may communicate the healthcare transaction to the determined healthcare benefits provider. The healthcare benefits provider may generate the benefits response message and communicate the benefits response message to the service provider. Upon receipt of the benefits response message, the service provider may determine whether the benefits response message is associated with a healthcare benefits provider that is a contracted entity. A contracted entity may, for example, permit the healthcare provider device 102 and/or the service provider computer 104 to access and/or display information that would otherwise not be accessible for a non-contracted entity. Accordingly, in one example, if the healthcare transaction is linked to a contracted benefits provider, the benefit response message may provide the healthcare provider with all available benefits response information including in the message which may include, without limitation, patient co-pay information, formulary information, formulary alternatives, step-therapy directives, prior authorization and/or rejection information, general care information, advertisements, comments, or the like. For example, the formulary alternative information may be a generic medication (e.g., zolpidem tartrate) that has been deemed to be a suitable substitute for a brand name medication (e.g., Ambien). If, however, the healthcare transaction is not linked to a contracted benefits provider, the healthcare provider may be permitted to display only a limited portion of the benefit response message. For example, the service provider may only be permitted to display the patient co-pay information for the formulary and/or treatment included in the submitted healthcare transaction.

### System Overview

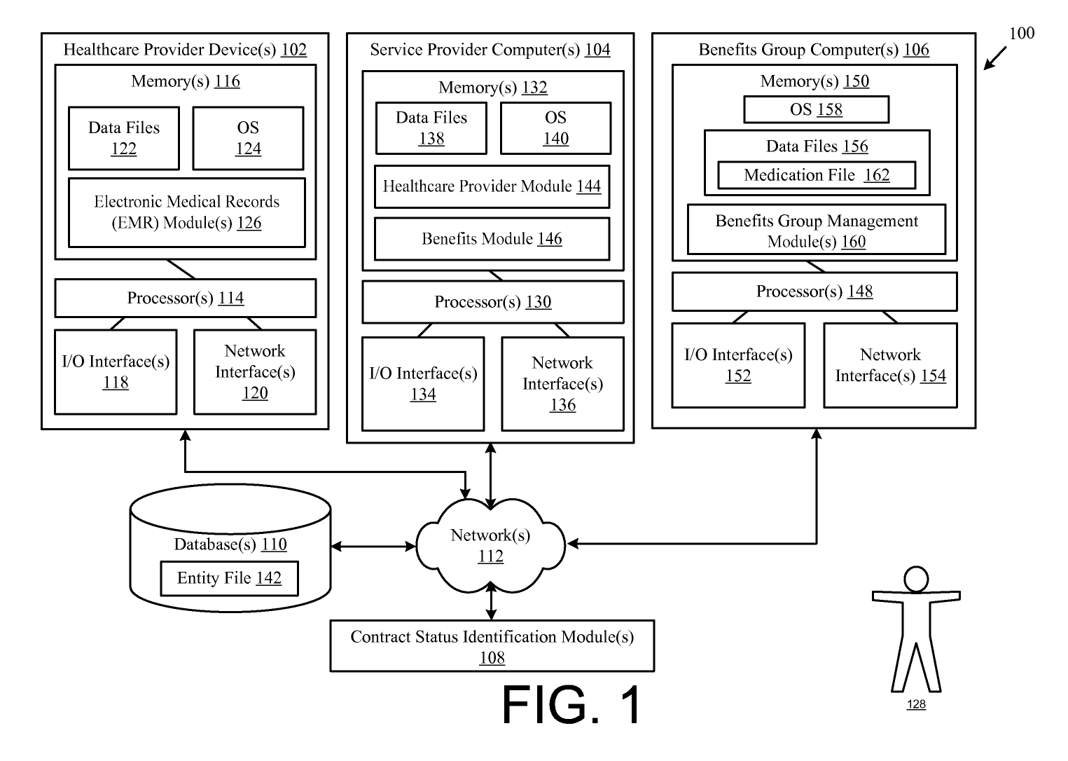

FIG. 1 illustrates an example system 100 for facilitating, among other things, determining and communicating a benefits response message. As shown in FIG. 1, the system 100 may include one or more healthcare provider devices 102, service provider computers 104, and benefits group computers 106. As desired, each of the healthcare provider devices 102, service provider computers 104, and benefits group computers 106 may include one or more processing devices that may be configured for accessing and reading associated computer-readable media having stored data thereon and/or computer-executable instructions for implementing various embodiments of the disclosure.

The exemplary healthcare provider device 102 is not intended to be limited to physician offices alone and may otherwise be associated with any healthcare provider, such as, for example, a prescriber (such as a hospital, urgent care center, dentist, etc.). While the exemplary healthcare provider device 102 references a physician office, this is for example only and is not intended to be limiting in any manner.

Additionally, in one or more example embodiments of the disclosure, the service provider computers 104 may include or otherwise be in communication with a contract status identification module 108 or contract status identification application. The contract status identification module 108 may include computer-executable instructions operable for determining during an adjudication or a pre-adjudication process, whether a healthcare transaction may be processed by one or more contracted benefit providers.

The contract status identification module 108 may be further operable to access and/or be in communication with one or more suitable databases and/or data storage devices 110. The contract status identification module 108 may access benefits group information associated with discount program, a third party payor such as a pharmacy benefit manager and/or insurance company, or the like. In one example implementation, the contract status identification module 108 may compare accessed benefits group information to information included in the healthcare transaction to determine whether an identified healthcare benefits group is a contracted healthcare benefits group. For example, contract status identification module 108 may access stored benefit group information, including, but not limited to healthcare benefit group numbers, pharmacy benefit manager identification numbers, benefit group names, routing information, contract status indication, other benefits group related information including address (including street address, city, state/province, and zip/postal code, and the like. The contract status may be indicated by “contract status=‘y’” if the benefits group is a contracted entity or “contract status≠‘y’” if the benefit group is a non-contracted entity. Generally, network devices and systems, including one or more healthcare provider devices 102, service provider computers 104, and benefits group computers 106, may include or otherwise be associated with suitable hardware and/or software for transmitting and receiving data and/or computer-executable instructions over one or more communication links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer-executable instructions, each of the network devices may form a special-purpose computer or particular machine. As used herein, the term “computer-readable medium” describes any medium for storing computer-executable instructions.

As shown in FIG. 1, the one or more healthcare provider devices 102, service provider computers 104, and benefits group computers 106 may be in communication with each other via one or more networks, such as network 112, which may include one or more independent and/or shared private and/or public networks including the Internet or a publicly switched telephone network. In other example embodiments, one or more components of the system 100 may communicate via direct connections and/or communication links. Each of these components—the healthcare provider device 102, service provider computer 104, benefits group computers 106, and the network 112—will now be discussed in further detail. Although the components are generally discussed as singular components, as may be implemented in various example embodiments, in alternative exemplary embodiments each component may include any number of suitable computers and/or other components.

With continued reference to FIG. 1, one or more healthcare provider devices 102 may be associated with a healthcare provider, for example, a physician, a nurse, a nurse practitioner, a physician's assistant, a hospital, a physician's office, a dentist, etc. A healthcare system device 102 may be any suitable processor-driven device that facilitates the processing of healthcare transactions made by or on behalf of healthcare office (e.g., a prescription including, but not limited to, a patient identification (i.e., a patient identifier), patient name, healthcare benefit group identification (i.e., a healthcare benefit group identifier), healthcare benefit group name, prescribing physician identification (i.e., a physician identifier), prescribing physician name, medication identification (i.e., a medication identifier), and medication name, etc.), the communication of healthcare transactions to the service provider computer 104, and/or the receipt, processing, and display of responses received from the service provider computer 104. For example, the healthcare provider device 102 may be a computing device that includes any number of server computers, mainframe computers, networked computers, desktop computers, personal computers, mobile devices, smartphones, digital assistants, personal digital assistants, tablet devices, Internet appliances, application-specific integrated circuits, microcontrollers, minicomputers, and/or any other processor-based devices. The healthcare provider device 102 having computer-executable instructions stored thereon may form a special-purpose computer or other particular machine that is operable to facilitate the processing of transactions/requests for healthcare information made by or on behalf of a healthcare provider and the communication of requested healthcare information and other healthcare transactions to the service provider computer 104. Additionally, in certain embodiments, the operations and/or control of the healthcare provider device 102 may be distributed among several processing components. In addition to including one or more processors 114, the healthcare provider device 102 may further include one or more memory devices (or memory) 116, one or more input/output (“I/O”) interfaces 118, and one or more network interfaces 120. The memory devices 116 may be any suitable memory devices, for example, caches, read-only memory devices, random access memory devices, magnetic storage devices, removable storage devices, etc. The memory devices 116 may store data, executable instructions, and/or various program modules utilized by the healthcare provider device 102, for example, data files 122, an operating system (“OS”) 124, and/or an electronic medical records (EMR) module 126.

The OS 124 may be a suitable software module that controls the general operation of the healthcare provider device 102. The OS 124 may also facilitate the execution of other software modules by the one or more processors 114, for example, the EMR module 126. The OS 124 may be any operating system known in the art or which may be developed in the future including, but not limited to, Microsoft Windows®, Apple OSX™, Apple iOS™ Google Android™, Linux, Unix, or a mainframe operating system.

The EMR module 126 may be a software application(s), including, but not limited to, a dedicated program: for making diagnoses; for determining prescriptions, over-the-counter medications, products or other healthcare services associated with one or more diagnoses; for creating prescription transactions (including e-prescription transaction (i.e., electronic prescription order transaction, e-script, or e-prescription)); for reading and/or updating medical records, as well as interacting with the service provider computer 104. For example, a user 128, such as a physician, nurse practitioner, and/or any other prescriber, may utilize the EMR module 126 during a patient visit, for recording and/or updating medical records, and/or for preparing and providing a healthcare transaction e.g., a prescription including, but not limited to, a patient identification (i.e., a patient identifier), patient name, healthcare benefit group identification (i.e., a healthcare benefit group identifier), healthcare benefit group name, prescribing physician identification (i.e., a physician identifier), prescribing physician name, medication identification (i.e., a medication identifier), and medication name, etc.) to the service provider computer 104. Furthermore, the healthcare provider device 102 may utilize the EMR module 126 to retrieve or otherwise receive data, messages, or responses (i.e., the benefits response message) from the service provider computer 104 and/or other components of the system 100.

The one or more I/O interfaces 118 may facilitate communication between the healthcare provider device 102 and one or more input/output devices, for example, one or more user interface devices, such as a display, keypad, control panel, touch screen display, remote control, microphone, etc., that facilitate user interaction with the healthcare provider device 102. For example, the one or more I/O interfaces 118 may facilitate entry of information associated with a healthcare transaction by a healthcare provider, such as a physician. The one or more network interfaces 122 may facilitate connection of the healthcare provider device 102 to one or more suitable networks, for example, the network 112 illustrated in FIG. 1. In this regard, the healthcare provider device 102 may receive and/or communicate information to other network components of the system 100, such as the service provider computer 104.

With continued reference to FIG. 1, one or more service provider computers 104 may be associated with a service provider. A service provider computer 104 may include, but is not limited to, any suitable processor-driven device that is configured for receiving, processing, and fulfilling healthcare transactions from the healthcare provider device 102 including a prescription (including, but not limited to, a patient identification (i.e., a patient identifier), patient name, a healthcare benefit group identifier (e.g., a group ID number and/or a Bank Identification Number (BIN)), healthcare benefit group name, prescribing physician identifier (e.g., National Provider Identifier (NPI) number and/or a provider identification issued by the Drug Enforcement Agency (DEA)), prescribing physician name, a medication identifier (e.g., a National Drug Code (NDC) identification), and medication name, etc.), benefits determinations, eligibility determinations, other healthcare requests and/or other activities. In addition, the service provider computer 104 may also include, any suitable processor-driven device that is configured for receiving, processing, and communicating adjudication or pre-adjudication benefit response messages from the benefits group computer 106 including formulary alternative information (i.e., generic pharmaceutical information), patient co-pay information associated with varying formularies, etc. Any number of healthcare provider devices 102, and benefits group computers 106 may be in communication with the service provider computer 104 as desired in various example embodiments.

The service provider computer 104 may include any number of special-purpose computers or other particular machines, application-specific integrated circuits, microcontrollers, personal computers, minicomputers, mainframe computers, servers, networked computers, and/or other processor-driven devices. In certain embodiments, the operations of the service provider computer 104 may be controlled by computer-executed or computer-implemented instructions that are executed by one or more processors associated with the service provider computer 104 to form a special-purpose computer or other particular machine that is operable to facilitate the receipt, routing, and/or processing of healthcare requests,healthcare transactions, and/or benefit response messages. The one or more processors that control the operations of the service provider computer 104 may be incorporated into the service provider computer 104 and/or may be in communication with the service provider computer 104 via one or more suitable networks. In certain example embodiments, the operations and/or control of the service provider computer 104 may be distributed among several processing components.

Similar to the healthcare provider device 102, the service provider computer 104 may include one or more processors 130, one or more memory devices 132, one or more input/output (“I/O”) interfaces 134, and one or more network interfaces 136. The one or more memory devices 132 may be any suitable memory device, for example, caches, read-only memory devices, etc. The one or more memory devices 132 may store data, executable instructions, and/or various program modules utilized by the service provider computer 104, for example, data files 138 and an operating system (“OS”) 140. The OS 140 may be any operating system known in the art or which may be developed in the future including, but not limited to, Microsoft Windows®, Apple OSX™, Linux, Unix, Apple iOS™, Google Android™, or a mainframe operating system. The OS 140 may be a suitable software module that controls the general operation of the service provider computer 104 and/or that facilitates the execution of other software modules.

According to an example embodiment, the data files 138 may store healthcare transaction records received from various healthcare provider devices 102, and/or benefit response messages received from various benefits group computers 106. The data files 138 may also store any number of suitable routing tables that facilitate determining the destination of communications received from a healthcare provider device 102, and/or a benefits group computers 106. In one or more example embodiments of the disclosure, the service provider computer 104 may include or otherwise be in communication with one or more suitable databases and/or data storage devices 110 including, but not limited to, one or more healthcare entity files 142 including at least one or more adjudication message files 144 and one or more contract status files 146.

The one or more entity files 142 may contain, entity information pertaining to the benefits group computers 106. In one example implementation, the benefits group computers 106 may communicate information associated with healthcare entities (i.e., a healthcare benefit group identifier (e.g., a group ID number and/or a Bank Identification Number (BIN)) and healthcare benefit group name) to the service provider 104. The service provider 104 may facilitate storage of the healthcare entity information in an entity files 142.

The service provider computer 104 may include additional program modules for performing other processing methods described herein. Those of ordinary skill in the art will appreciate that the service provider computer 104 may include alternate and/or additional components, hardware, or software without departing from the scope of the disclosure. For example, the service provider 104 may include a healthcare provider module 144. The healthcare provider module 144 may include computer-executable instructions for interacting with the healthcare provider device 102 for the purpose of facilitating, among other things, the timely and efficient receipt and/or communication of healthcare transaction information (i.e, the prescription including, without limitation, the patient identifier, the physician identifier, the healthcare benefits group identifier, the medication identifier), and/or the benefit response message. In certain exemplary embodiments, the healthcare provider module 144 may be implemented as computer-implemented instructions of the memory 132 of the service provider computer 104 or otherwise may be located within the service provider computer 104. Alternatively, the healthcare provider module 144 may also be implemented as computer-implemented instructions of a memory of a separate computing entity or processor-based system, according to another example embodiment of the disclosure.

The service provider computer 104 may also include a benefits module 150. The benefits module 146 may include computer-executable instructions operable to facilitate interaction with the benefits group computer 106. The computer-executable instructions may be further operable to facilitate the processing of the contract entity information. For example, when the service provider computer 104 receives the benefit response message, the benefits module may access the one or more entity files 142 to determine whether the healthcare benefits group identifier included in the received benefits group message is a contracted benefits group. If the benefits group is contracted, the benefits module 146 may facilitate transmitting any and all benefits group message information (i.e, co-pay information, formulary information, formulary alternatives, step-therapy directives, prior transaction authorization/rejection information, general care information, advertisements, comments, or the like) to the healthcare provider device. If the originating benefits group is not a contracted entity as indicated by an affirmative notation in the corresponding entity file 142, the benefits module 146 may facilitate transmitting the co-pay information to the healthcare provider device. In certain exemplary embodiments, the benefits module 146 may be implemented as computer-implemented instructions of the memory 132 of the service provider computer 104 or otherwise may be located within the service provider computer 104. Alternatively, the benefits module 146 may also be implemented as computer-implemented instructions of a memory of a separate computing entity or processor-based system, according to another example embodiment of the disclosure.

With continued reference to the service provider computer 104, the one or more I/O interfaces 134 may facilitate communication between the service provider computer 104 and one or more input/output devices, for example, one or more user interface devices, such as a display, keypad, control panel, touch screen display, remote control, microphone, etc., that facilitate user interaction with the service provider computer 104. The one or more network interfaces 136 may facilitate connection of the service provider computer 104 to one or more suitable networks, for example, the network 112 illustrated in FIG. 1. In this regard, the service provider computer 104 may communicate with other components of the system 100.

With continued reference to FIG. 1, any number of benefits group computers 106 may be associated with any number of healthcare benefits management groups and/or pharmacy benefits management groups (i.e., benefits groups). Each benefits group computer 106 may be any suitable processor-driven device that facilitates creating and/or communicating the benefit response message to the service provider computers 104. For example, the benefits group computer 106 may be a processor-driven device associated with (i.e., located within) a healthcare benefits management group. As desired, the benefits group computer 106 may include any number of special-purpose computers or other particular machines, application-specific integrated circuits, microcontrollers, personal computers, minicomputers, mainframe computers, servers, and the like. In certain example embodiments, the operations of the benefits group computer 106 may be controlled by computer-executed or computer-implemented instructions that are executed by one or more processors associated with the benefits group computer 106 to form a special-purpose computer or other particular machine that is operable to facilitate the creation and/or communication of the benefit response messages (e.g., co-pay information, a formulary alternative, step-therapy information, prior transaction authorization/rejection information, care or usage instructions, etc.) to the service provider computer 104. The one or more processors that control the operations of the benefits group computer 106 may be incorporated into the benefits group computer 106 and/or may be in communication with the benefits group computer 106 via one or more suitable networks. In certain example embodiments, the operations and/or control of the benefits group computer 106 may be distributed among several processing components.

Similar to other components of the system 100, each benefits group computer 106 may include one or more processors 148, one or more memory devices 150, one or more I/O interfaces 152, and one or more network interfaces 154. The one or more memory devices 150 may be any suitable memory devices, for example, caches, read-only memory device, random access memory devices, magnetic storage devices, removable memory devices, etc. The one or more memory devices 150 may store data, executable instructions, and/or various program modules utilized by the benefits group computer 106, for example, data files 156, an OS 158, and a benefits group management module 160. The data files 156 may include any suitable information that is utilized by the benefits group computer 106. In addition, the data files 156 include one or more medication files 162 including, but not limited to, medication name, medication identification information (i.e., the NDC) patient co-pay information, formulary information, formulary alternatives, step-therapy directives, prior transaction authorization/rejection information, or general care information, advertisements, comments, or the like. Medication files 162 may include information provided by the benefits group computer 106, the service provider 104, pharmaceutical manufacturers, pharmaceutical suppliers, government agencies (i.e., HSRA, etc.), or the like.

The OS 158 may be a suitable software module that controls the general operation of the benefits group computer 106. The OS 158 may also facilitate the execution of other software modules by the one or more processors 148. The OS 162 may be any operating system known in the art or which may be developed in the future including, but not limited to, Microsoft Windows®, Apple OSX™, Linux, Unix, Apple iOS™, Google Android™, or a mainframe operating system.

The one or more I/O interfaces 152 may facilitate communication between the benefits group computer 106 and one or more input/output devices, for example, one or more user interface devices, such as a display, keypad, control panel, touch screen display, remote control, microphone, etc., that facilitate user interaction with the benefits group computer 106. The one or more network interfaces 154 may facilitate connection of the benefits group computer 106 to one or more suitable networks, for example, the network 112 illustrated in FIG. 1. In this regard, the benefits group computer 106 may create and communicate contracted prescriber messages and/or other communications to the service provider computer 104.

The benefits group management module 160 may be a software application(s), including a dedicated program, for creating one or more benefit response messages, facilitating patient billing, etc., as well as interacting with the service provider computer 104. For example, a benefits group management employee may utilize the benefits group management module 160 when creating the one or more benefit response message, billing a patient, or preparing and providing a healthcare transaction request for information to the service provider computer 104. Furthermore, the benefits group computer 106 may utilize the benefits group management module 160 to retrieve or otherwise receive data, messages, or responses from the healthcare provider device 102 and/or other components of the system 100.

The network 112 may include any telecommunication and/or data network, whether public, private, or a combination thereof, including a local area network, a wide area network, an intranet, the Internet, intermediate handheld data transfer devices, and/or any combination thereof and may be wired and/or wireless, or any combination thereof. The network 112 may also allow for real time, offline, and/or batch transactions to be transmitted between or among the healthcare provider device 102, the service provider computer 104, and the benefits group computer 106. Various methodologies as described herein, may be practiced in the context of distributed computing environments. Although the service provider computer 104 is shown for simplicity as being in communication with the healthcare provider device 102, or the benefits group computer 106 via one intervening network 112, it is to be understood that any other network configurations are possible. For example, intervening network 112 may include a plurality of networks, each with devices such as gateways and routers for providing connectivity between or among the components of the system 100. Instead of or in addition to the network 112, dedicated communication links may be used to connect various devices in accordance with an example embodiment. For example, the service provider computer 104 may form the basis of network 112 that interconnects the healthcare provider device 102, and the benefits group computer 106.

Those of ordinary skill in the art will appreciate that the system 100 shown in and described with respect to FIG. 1 is provided by way of example only. Numerous other operating environments, system architectures, and device and network configurations are possible. Other system embodiments can include fewer or greater numbers of components and may incorporate some or all of the functionality described with respect to the system components shown in FIG. 1. For example, in an exemplary embodiment, the service provider computer 104 (or other computer) may be implemented as a specialized processing machine that includes hardware and/or software for performing the methods described herein. In addition, at least a portion of the processor 130 and/or the processing capabilities of the service provider computer 104, the healthcare provider module 148, and/or the benefits module 150, may be implemented as part of the benefits group computer 106. Accordingly, embodiments of the disclosure should not be construed as being limited to any particular operating environment, system architecture, or device or network configuration.

Operational Overview

Certain portions of the exemplary methods below will be described with reference to determining and communicating a benefits response message generated during an adjudication or pre-adjudication process of a healthcare transaction. In one example implementation, the healthcare transaction may include a prescription, a predetermination of benefits request; a prescription claim or billing request, or a healthcare order transaction. While the methods described below are in reference to a healthcare transaction, each form of healthcare transaction should be individually read as being used in the methods described below.

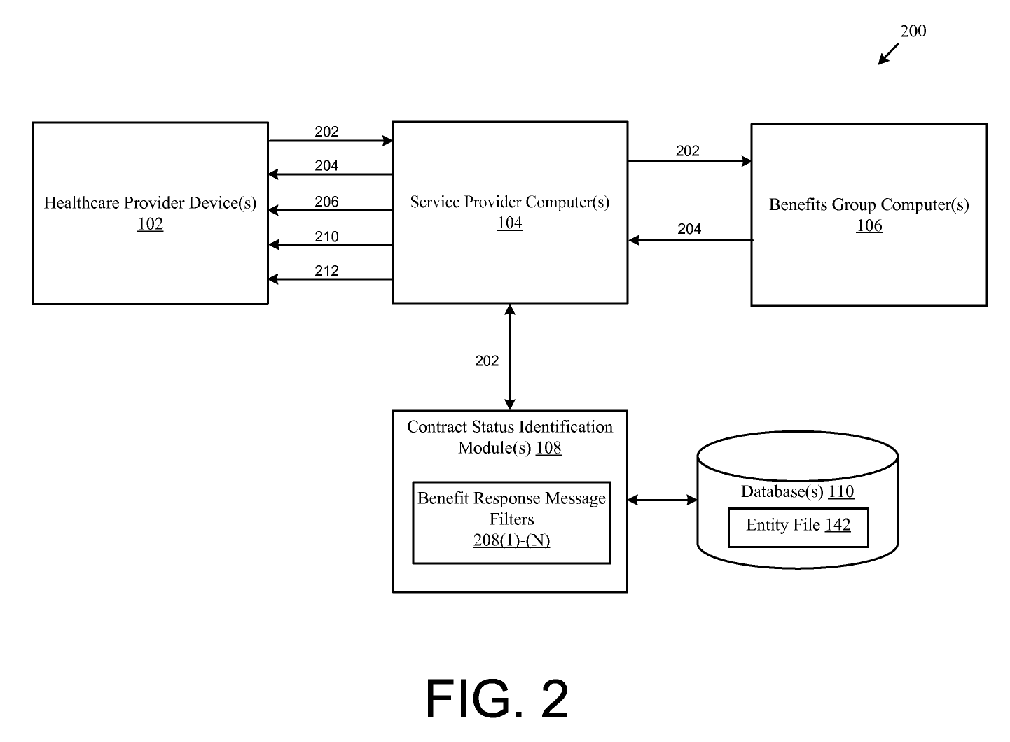

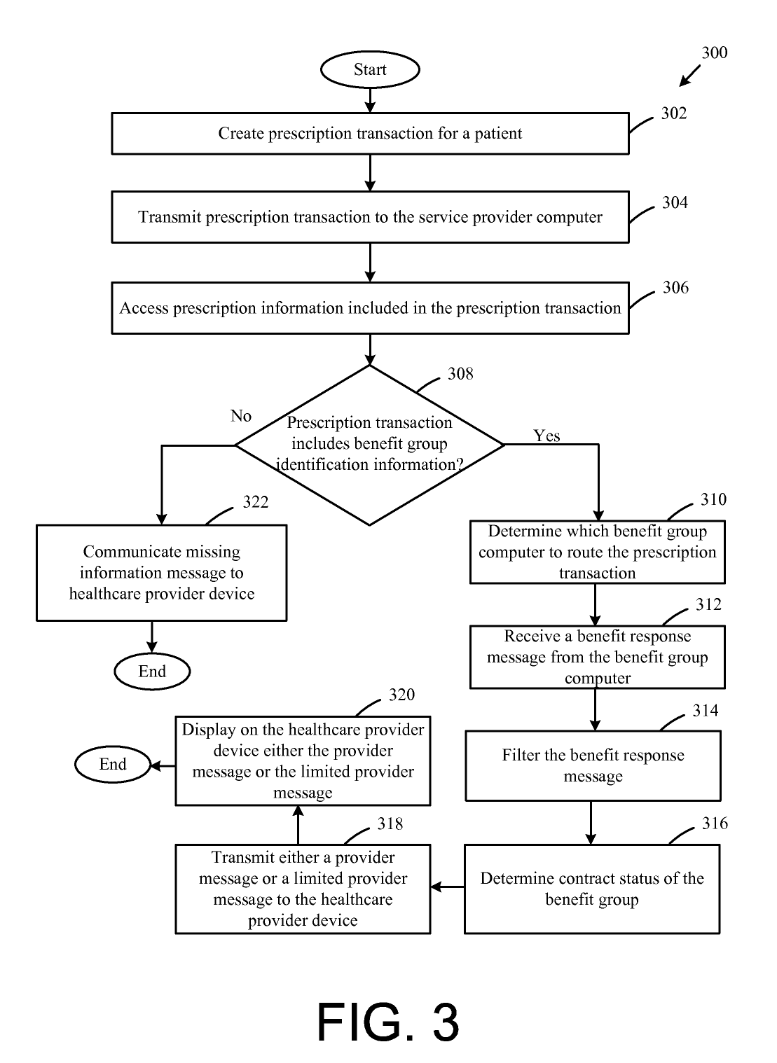

FIG. 2 illustrates an example block diagram 200 for receiving and communicating a healthcare transaction, according to an example embodiment of the disclosure. FIG. 3 illustrates an example method 300 for receiving and communicating a healthcare transaction, according to an example embodiment of the disclosure. The block diagram 200 of FIG. 2 will be discussed in conjunction with the method of 300 of FIG. 3.

Referring now to FIGS. 1, 2, and 3, the exemplary method 300 begins at the START step and continues to step 302, where the healthcare provider device, such as the healthcare provider device 102, may be utilized to create a prescription transaction 202. In one example implementation, the healthcare provider device 102 may employ an electronic medical records (EMR) module 126 to create the prescription transaction 202 (i.e., a predetermination of benefits transaction, healthcare claim transaction, prescription claim or billing request, healthcare order transaction, or e-prescription transaction (i.e., electronic prescription order transaction, e-script, or e-prescription)) for a patient prescription according to National Council for Prescription Drug Programs (NCPDP) standards. As an example, the prescription transaction 202 may include one or more of the following information (required information indicated by [REQUIRED]):
Payer ID/Routing Information
   Transaction Payer Identifier(s) that designates a destination of the healthcare transaction 210 (e.g., Bank Information Number (BIN), BIN and PCN, or BIN Number and Group ID)
Patient Information
   Name (e.g. Patient Last Name, Patient First Name, etc.)
   Date of Birth of Patient
   Age of Patient
   Patient Gender Code
   Patient Address (e.g. Street Address, City, State/Province, Zip Code, etc.)
   Patient Contact Information (e.g. patient telephone number, email address, etc.)
   Patient Health Condition Information (e.g., pregnant)
   Patient Identification Identifier (such as, but not limited to, patient social security number, a subset of the patient social security number, health insurance claim number (HICN), cardholder ID, etc.)
Benefits Information [REQUIRED]
   Cardholder Name (e.g. Cardholder First Name, Cardholder Last Name)
   Cardholder ID and/or other identifier (e.g. person code)
   Group ID and/or Group Information
Prescriber Information
   Primary Care Provider ID or other identifier (e.g. National Provider Identifier (NPI) code)
   Primary Care Provider Name (e.g. Last Name, First Name)
   Prescriber ID or other identifier (e.g. NPI code, Drug Enforcement Agency (DEA) number)
   Prescriber Name (e.g. Last Name, First Name)
   Prescriber Contact Information (e.g. Telephone Number)
   Pharmacy or other Healthcare Provider Information (e.g. store name, chain identifier, etc.)
   Pharmacy or other Healthcare Provider ID (e.g. NPI code)
Claim Information
   Drug, service, or product information (e.g. via National Drug Code NDC)) [REQUIRED]
   Prescription/Service Reference Number
   Date Prescription Written
   Quantity Dispensed
   Days' Supply
   Diagnosis/Condition
   Pricing information for the drug/service/product (e.g. network price, Usual & Customary price)
   Number of Refills Authorized
   One or more Drug Utilization (DUR) Codes
   Date of Service.

At step 304, the healthcare provider device 102 may communicate the prescription transaction 202 (i.e., a predetermination of benefits transaction, healthcare claim transaction, prescription claim or billing request, healthcare order transaction, or e-prescription transaction (i.e., electronic prescription order transaction, e-script, or e-prescription)) to the service provider computer 104. In one example implementation, the service provider computer 104 may employ the healthcare provider module 144. The healthcare provider module 144 may be utilized by the service provider computer 104 to receive the prescription transaction 202. For example, the healthcare provider device 102 may employ the EMR module 126 to transmit the prescription transaction 202 to the healthcare provider module 144 of the service provider computer 104 via one or more suitable networks 112 (e.g., a wide area network, the Internet, a cellular network, etc.).

At step 306, the service provider computer 104 may access prescription transaction information included in the prescription transaction 202. Prescription transaction information may include information identified at step 302, including but not limited to, a patient identification (i.e., a patient identifier), patient name, a healthcare benefit group identifier (e.g., a group ID number and/or a Bank Identification Number (BIN)), healthcare benefit group name, prescribing physician identifier (e.g., National Provider Identifier (NPI) number and/or a provider identification issued by the Drug Enforcement Agency (DEA)), prescribing physician name, a medication identifier (e.g., a National Drug Code (NDC) identification), and medication name, etc.)

At step 308, the service provider may determine whether the prescription transaction 202 includes information needed for the service provider to determine the one or more benefit group computers 106 to route the prescription transaction 202 for further processing. For example, the healthcare provider module 144 may parse the prescription transaction 202 to identify prescription transaction information that may be utilized by the service provider to determine one or more benefit group computers 106 to route the prescription transaction 202 for further processing. For example, the healthcare provider module 144 may parse the prescription transaction 202 to identify at least a healthcare benefits group number or a pharmacy benefits manager identification number. In some implementations, the benefits group identification may include, without limitation, a group ID number and/or a Bank Identification Number (BIN). If a benefits group identification and/or one or more benefits group names are identified, then the YES branch is followed and processing may proceed to step 310. If the benefits group identification and/or one or more benefits group names are not identified in the prescription transaction 202, then the NO branch is followed and processing may proceed to step 322.

At step 310, the service provider may determine the one or more benefit group computers 106 to route the prescription transaction 202 for further processing. In one example, the service provider may access the entity file 142 to determine routing information. The entity file 142 may include tables with at least healthcare benefit group numbers, pharmacy benefit manager identification numbers, benefit group names, routing information, contract status indication, other benefits group related information including address (including street address, city, state/province, and zip/postal code, and the like. The healthcare provider benefits module may compare the identified one or more benefit group computers from the prescription transaction information identified in the prescription transaction 202 with the entity file 142 to determine which benefit group computer 106 to route the prescription transaction 202 for further processing. As described above, the benefits group computer 106 may be associated with a discount program, a third party payor such as a pharmacy benefit manager and/or insurance company, or the like.

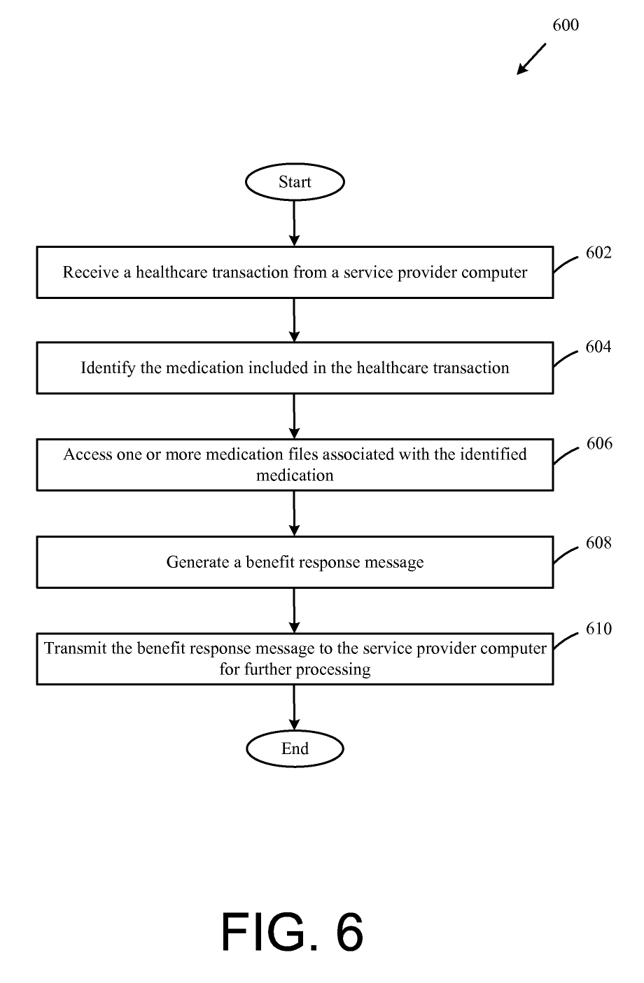

At step 312, the service provider may receive a benefit response message 204 from benefit group computer 108. At step 314, the service provider computer 104 may employ one or more benefit response message filters 208(1)-(N) to filter the benefit response message 204. In some implementations, a filtered benefit response message 204 may designate, without limitation, a first portion including at least patient co-pay information, and a second portion including at least one of formulary information, formulary alternatives, step-therapy directives, prior authorization and/or rejection information, general care information, advertisements, comments, or the like. Discussion of composing a benefit response message may be found below at least with regard to FIG. 6.

At step 316, the service provider may determine whether the benefits group associated with the benefit response message 204 is a contracted benefits group. A contracted benefits group may, for example, permit the healthcare provider device 102 and/or the service provider computer 104 to access and/or display information that would otherwise not be accessible for a non-contracted entity.

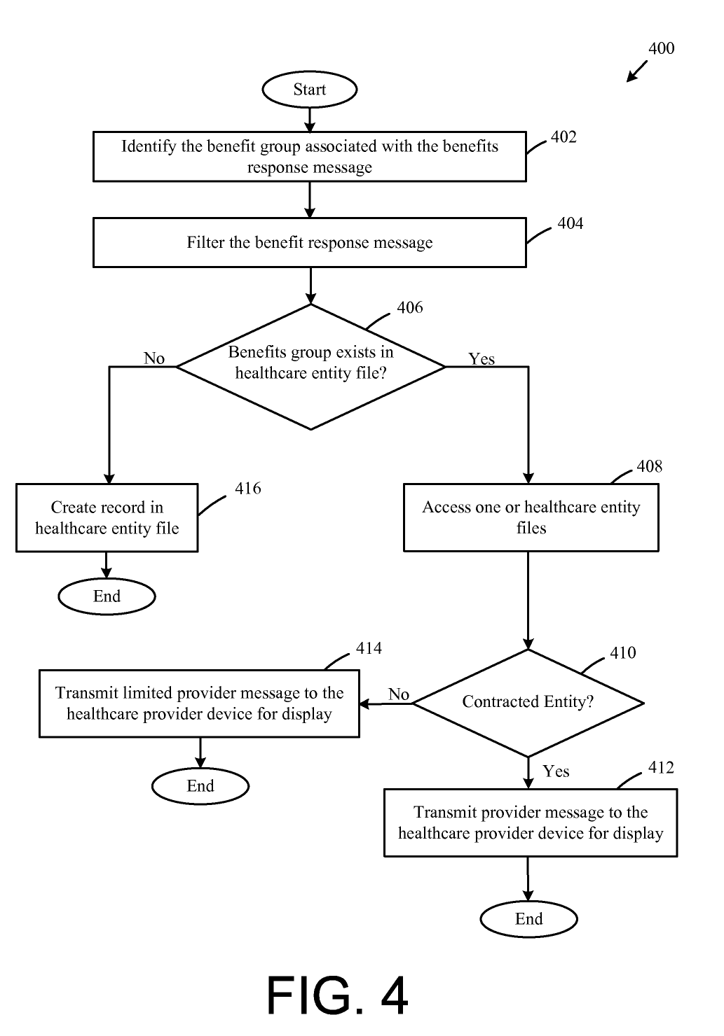

In one example implementation, if the service provider computer 104 determines that the benefit group computer 106 is a contracted entity, the service provider computer 104 may transmit a provider message 206 including both the first portion (i.e., patient co-pay information) of the benefit response message 204 and the second portion (i.e., formulary information, formulary alterative information, etc.) of the benefit response message 204 (i.e., formulary information, formulary alterative information, etc.) to the healthcare provider device 102. If however, the service provider computer 104 determines that the benefit group computer 106 is not a contracted entity, the service provider computer 104 may transmit a limited benefit response message 210 to the healthcare provider device 102. The limited benefit response message 210 may include an accessible portion as well as non-accessible portion. In one example implementation, the accessible portion of the limited benefit response message 210 may include the first portion of the benefit response message 204 (i.e., patient co-pay information). Discussion of the determination of a contracted entity may be found below at least with regard to FIG. 4.

At step 318, the service provider computer 104 may transmit the provider message 206 or the filtered benefit response message 210 to the healthcare provider device 102. In one example implementation, the service provider computer 104 may employ the healthcare provider module 144 to communicate the provider message 206 or the non-contracted provider message 210 to the EMR module 126 of the healthcare provider device 102.

At step 320, the healthcare provider device 102 may access and/or display information in the provider message 206 or the limited benefit response message 210 to the EMR module 126 of the healthcare provider device 102. The method 300 may end after step 318.

At step 322, if the prescription transaction does not include identifiable benefit group information, the service provider 104 may communicate a missing information message 212 to the healthcare provider device 102. The missing information message may indicate that the prescription transaction 202 was incomplete. In one example implementation, the missing information message 212 may highlight the missing information identified at step 308. For example, the missing information message 212 may indicate that prescription transaction 202 does not contain identifiable benefits group identification information and/or benefits group name information. The method 300 may end after step 320.

FIG. 4 illustrates an example method 400 for determining the status of a benefits group, according to an example embodiment of the disclosure. The block diagram 200 of FIG. 2 will be discussed in conjunction with the method 400.

Referring now to FIGS. 1, 2, 3, and 4, the exemplary method 300 begins at the START step and continues to step 402, where the service provider computer 104 may utilize benefits module 150 to identify the benefit group associated with the benefits response message 204. For example, service provider may employ the benefits module 150 to parse the benefits response message 204 to identify at least a benefits group identification (e.g., healthcare benefits group number, a pharmacy benefits manager identification number, or the like). In some implementations, the benefits group identification may include, without limitation, a group ID number and/or a Bank Identification Number (BIN). The benefit response message 204 may further include, patient co-pay information, formulary information, formulary alternatives, step-therapy directives, prior authorization and/or rejection information, general care information, advertisements, comments, or the like. As described above, the benefits group computer 106 may be associated with a discount program, a third party payor such as a pharmacy benefit manager and/or insurance company, or the like.

At step 404, the service provider computer 104 may filter the benefit response message 204. In one example implementation, the service provider computer 104 may employ one or more benefit response message filters 208(1)-(n) to filter the benefit response message 204. The filtered benefit response message 204 may identify the first portion of the benefit response message 204 (i.e., patient co-pay information) as accessible for review/display by the healthcare provider device 102 for benefit groups that are found to contracted entities as well benefit groups found to be non-contracted entities. The filtered benefit response message may further identify the second portion (i.e., formulary information, formulary alterative information, etc.) of the benefit response message 204 as only accessible for review/display by the healthcare provider device 102 only if the benefit group is a contracted entity. For example, the healthcare provider device 102 may be permitted to see that there is a second portion of the filtered benefit response message 210, however, they are not able to view the information contained within the second portion of the filtered benefit response message 204.

At step 406, the service provider 104 may determine whether an entity file 142 exists for the benefits group identified in the benefits response message 204. In one example implementation, the service provider computer 104 may employ the benefits module 150 to parse the one or more healthcare entity files 142 and compare the identified benefit group in the benefits response 204 to information contained in the one or more entity files 142. If the benefits group identifier is identified as matching an existing entry in the healthcare entity file 142, then the YES branch is followed and processing may proceed to step 408. If a benefits group identifier is not identified as matching an existing entry in the healthcare entity file 142, then the NO branch is followed and processing may proceed to step 416.

At step 408, the service provider may access one or more entity files 142. In one example implementation, as indicated at step 310 the entity files 142 may include, without limitation, healthcare benefit group numbers, pharmacy benefit manager identification number, benefit group names, routing information, contract status indication, other benefits group related information including address (including street address, city, state/province, and zip/postal code, and the like. The contract status indication is utilized in identifying a benefit group, such as benefit group computer 106, as a contracted entity or as a non-contracted entity. In one example, the contract status may be indicated by “contract status=‘y’” if the benefits group is a contracted entity or “contract status ‘y’” if the benefit group is a non-contracted entity. A contracted entity may, for example, permit the healthcare provider device 102 and/or the service provider computer 104 to access and/or display information that would otherwise not be accessible for a non-contracted entity. For example, a non-contracted entity may permit the healthcare provider device 102 and/or the service provider 104 the ability to view only a patient's co-pay information. However, if the benefit group is a contracted entity, the healthcare provider device 102 and/or the service provider computer 104 may be able to view not only a patient's co-pay information, but additional information, such as general care information, formulary information, formulary alternatives, and the like.

At step 410, the service provider 104 may determine whether the benefits group indicated in benefits response message 204 is a contracted entity. In one example implementation, the service provider computer 104 may employ a contract status identification module 108 to determine whether the identified group identifier includes an indication of a contracted entity status or an indication of a non-contracted entity status. For example, the benefits group indicated in the entity file 142 may include a “contract status=‘y’” if the benefits group is a contracted entity or “contract status ‘y’” if the benefit group is a non-contracted entity. While the one or more entity files 142 are described with certain designations for contracted and non-contracted entities, it is to be appreciated that the one or more entity files 142 may represent benefit groups as contracted or non-contracted with any reasonable designation. If the one or more entity files 142 includes a “contract status=‘y’” for the identified benefit group, then the YES branch is followed and processing may proceed to step 412. If the one or more BIN tables includes a “contract status ‘y’” for the identified benefit group, then the NO branch is followed and processing may proceed to step 414.

At step 412, the service provider computer 104 may transmit the provider message 206 to the healthcare provider device 102, as detailed in FIG. 3 step 316. For example, provider message 206 may include the first portion (i.e., patient co-pay information) of the benefit response message 204 and the second portion (i.e., formulary information, formulary alternative information, etc.) of the benefit response message 204 (i.e., formulary information, formulary alterative information, etc.), both of which are accessible for review and/or display by the healthcare provider computer 102. In one example implementation, the service provider computer 104 may employ the healthcare provider module 144 to communicate the provider message 206 to the EMR module 126 of the healthcare provider device 102.

At step 414, the service provider computer 104 may transmit the limited benefit response message 210 to the healthcare provider device 102. In one example implementation, the service provider computer 104 may employ the healthcare provider module 144 to communicate the limited benefit response message 210 to the EMR module 126 of the healthcare provider device 102. Upon receipt of the non-contracted provider message 210, the healthcare provider device 102 may communicate a request to alter the status of the benefit group such that the healthcare provider device would be able to access all of the information (i.e., both the first portion and the second portion) included in the benefit response message 204. In one example implementation, the request to alter contractual status may be communicated to the benefit group computer 106 via the service provider 104.

At step 416, the service provider computer 104 may facilitate the creation of a benefits group record in the entity file 142. In example embodiments, a benefits group record may include benefits group identification information, such as, the identification information discussed at FIG. 3, step 302. For example, the service provider computer 104 may utilize the benefits module 150 to parse the prescription message 202 to identify whether a benefits group identifier exists in one or more fields of the prescription message 202. The benefits group identifier may include, without limitation, benefit group identification (e.g., a group ID number and/or a Bank Identification Number (BIN)) and/or a benefit group name. Additionally, the service provider computer 104 may parse the prescription message 202 to identify other benefits group related information including address (including street address, city, state/province, and zip/postal code) and a notation indicating the benefits group contractual status with the service provider.

Method 400 may end after step(s) 410, 414, and/or 416.

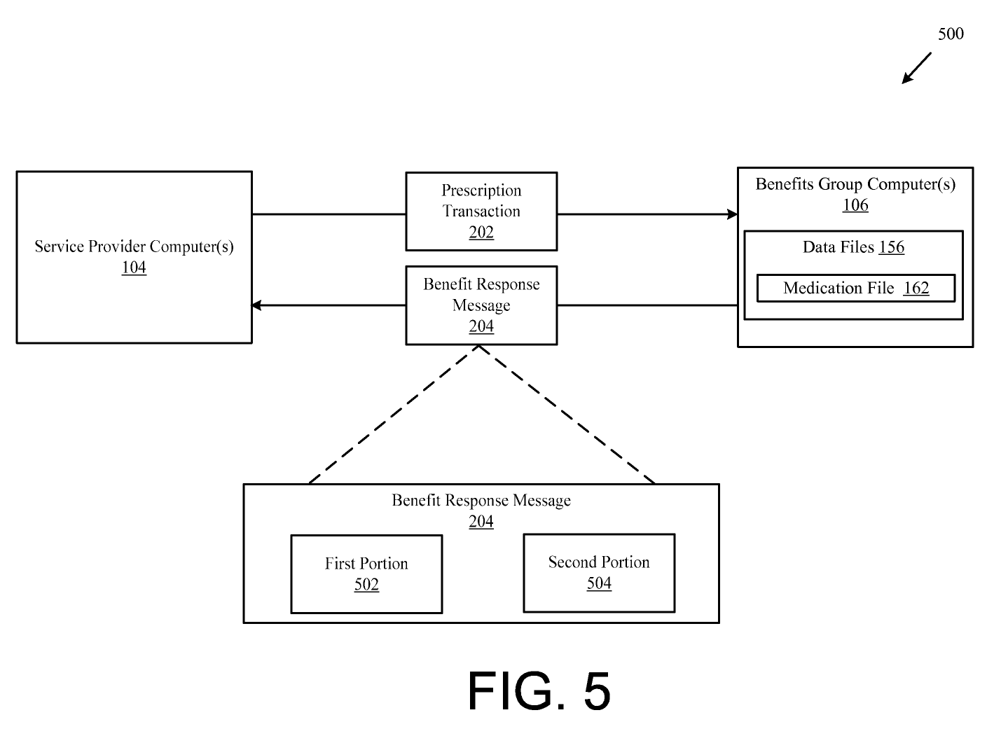

FIG. 5 illustrates an example block diagram 500 for generating a benefits response message according to an example embodiment of the disclosure. FIG. 6 illustrates an example method 600 for generating a benefits response message according to an example embodiment of the disclosure. The block diagram 500 of FIG. 5 will be discussed in conjunction with the method 600 of FIG. 6.

Referring now to FIGS. 1, 2, 5, and 6, the exemplary method 600 begins at the START step and continues to step 602, where one or more benefits group computers, such as the benefits group computer 106, may receive a prescription transaction 202 from the service provider computer 104. In one example implementation, the benefit group computer 106 may employ a benefits group management module 164 to receive the prescription transaction 202.

At step 604, the benefits group computer 106 may identify the medication name and/or the medication identification included in the prescription transaction 202. For example, the benefit group computer 106 may employ the benefit group management module 164 to parse the prescription transaction 202 to identify the medication identification and/or medication name information. In some implementations, the medication identification may include, without limitation, a National Drug Code (NDC) identification.

At step 606, the benefits group computer may access one or more medication files 162, stored in data files 156, with the identified medication name and/or medication identification. The one or more medication files 162 may, in some implementations, include information provided by the benefits group computer 106, the service provider 104, pharmaceutical manufacturers, pharmaceutical suppliers, government agencies (i.e., HSRA, etc.), or the like. In one non-limiting example, the one or more medication files 162 may be organized by medication name, medication identification information (i.e., the NDC), or the like. Each medication file 162 may include information associated with each medication, such as, patient co-pay information, formulary information, formulary alternatives, step-therapy directives, prior transaction authorization/rejection information, or general care information, advertisements, comments, or the like. For example, the medication file 162 may include formulary alternative information for a generic medication (e.g., zolpidem tartrate) deemed by recognized sources to be a suitable substitute for a brand name medication (e.g., Ambien).

At step 608, the benefits group computer 106 may generate a benefits response message 504. In some implementations, the benefits group computer 106 may employ the benefit group management module to generate the benefit response message 504 utilizing information found in the one or more medication files 162. In some implementations, the benefit response message may include a first portion 502 and a second portion 504. The first portion 502 may include, without limitation, patient co-pay information. The second portion 504 may include, without limitation, additional patient and/or medication information such as, for example, formulary information, formulary alternatives, step-therapy directives, prior transaction authorization and/or rejection information, general care information, advertisements, comments, or the like

At step 610, the benefits group computer 106 may transmit the benefits response message 204 including the first portion 502 and the second portion 504 to the service provider 104 for further processing. In one example implementation, the benefits group management module 164 of the benefits group computer 106 may communicate the benefits response message 204 to the service provider 104 via the benefits module 150 over network 114. Further of the processing of the benefit response message 204 may be found herein, for example, FIGS. 3 and 4.

Various block and/or flow diagrams of systems, methods, apparatus, and/or computer program products according to example embodiments of the disclosure are described above. It will be understood that one or more blocks of the block diagrams and steps of the flow diagrams, and combinations of blocks in the block diagrams and combinations of steps in the flow diagrams, respectively, can be implemented by computer-executable program instructions. Likewise, some blocks of the block diagrams and steps of the flow diagrams may not necessarily need to be performed in the order presented, or may not necessarily need to be performed at all, according to some embodiments.

These computer-executable program instructions may be loaded onto a special-purpose computer or other particular machine, one or more processors, or other programmable data processing apparatus to produce a particular machine, such that the instructions that execute on the computer, processor, or other programmable data processing apparatus create means for implementing one or more functions specified in the flow diagram step or steps. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram step or steps. As an example, various embodiments of the disclosure may provide for a computer program product including a computer-usable medium having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and steps of the flow diagrams support combinations of means for performing the specified functions, combinations of elements or steps for performing the specified functions, and program instruction means for performing the specified functions. It will also be understood that each block of the block diagrams and step of the flow diagrams, and combinations of blocks in the block diagrams and steps of the flow diagrams, can be implemented by special-purpose, hardware-based computer systems that perform the specified functions, elements or steps, or combinations of special-purpose hardware and computer instructions.

Many modifications and other embodiments of the disclosure set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method, comprising:
receiving, by one or more computers associated with a service provider from a healthcare provider computer associated with a healthcare provider, a healthcare transaction comprising prescription transaction information;
determining, by the one or more computers associated with the service provider, that the prescription transaction information includes at least one benefit group identifier;
routing, by the one or more computers associated with the service provider, the healthcare transaction to a benefit group associated with the benefit group identifier;
receiving, by the one or more computers associated with the service provider from the benefit group associated with the benefit group identifier, a benefit response message, the benefit response message including benefit response information comprising at least the benefit group identifier, a patient co-pay amount and one or more formulary alternatives;
determining, by the one or more computers associated with the service provider and based at least in part on the benefit group identifier, a contract status of the benefit group associated with the benefit response message, wherein;
if the determination is a contracted entity status, transmitting, by the one or more computers associated with the service provider, a provider message to the healthcare provider computer associated with the healthcare provider, the provider message including a first benefit information portion and a second benefit information portion accessible for display by the healthcare provider computer; and
if the determination is a non-contracted entity status, transmitting, by the one or more computers associated with the service provider, a limited provider message to the healthcare provider computer associated with the healthcare provider, the limited provider message including the first benefit information portion and the second benefit information portion, wherein only the first benefit information is accessible for display by the healthcare provider computer.

2. The method of claim 1, wherein the determining the contract status of the benefit group associated with the benefit response message comprises:
accessing, by the one or more computers associated with the service provider, one or more healthcare entity files;
comparing, by the one or more computers associated with the service provider, the benefit group identifier to healthcare entity information in the one or more healthcare entity files; and
identifying, by the one or more computers associated with the service provider, a contract status indicator in the healthcare entity information, wherein a contracted entity status has a positive designation and a non-contracted entity status has a negative designation.

3. The method of claim 2, wherein the healthcare entity information comprises at least one of a healthcare benefit group number, a pharmacy benefit manager identification number, one or more benefit group names, or routing information.

4. The method of claim 1 further comprising:
filtering, by the one or more computers associated with the service provider, the benefit response information included in the benefit response message; and
designating, by the one or more computers associated with the service provider, a first filtered portion of the benefit response information as the first benefit information portion and a second filtered portion of the benefit response information as the second benefit information portion.

5. The method of claim 4, wherein the first benefit information portion includes at least the patient co-pay amount.

6. The method of claim 4, wherein the second benefit information portion includes at least the one or more formulary alternatives.

7. The method of claim 6, wherein the second benefit information portion further includes at least one of patient general care information, additional formulary information, information associated with a prior transaction authorization, information associated with a prior transaction rejection, or one or more advertisements.

8. The method of claim 1, wherein the prescription transaction information includes at least a medication name or a medication identification.

9. The method of claim 1, wherein the benefit response message comprises medication information provided by one or more pharmaceutical manufacturers, one or more pharmaceutical suppliers, one or more governmental agencies, or one or more third party suppliers.

10. The method of claim 1, wherein the benefit group identifier is at least one of a benefit group identification number, a bank identification number (BIN) or a benefit group name.

11. A system comprising:
at least one memory operable to store computer-executable instructions; and
at least one processor configured to access the at least one memory and execute the computer-executable instructions to:
receive, from a healthcare provider computer associated with a healthcare provider, a healthcare transaction comprising prescription transaction information;
determine that the prescription transaction information includes at least one benefit group identifier;
route the healthcare transaction to a benefit group associated with the benefit group identifier;
receive, from the benefit group associated with the benefit group identifier, a benefit response message, the benefit response message including benefit response information comprising at least the benefit group identifier, a patient co-pay amount and one or more formulary alternatives;
determine, based at least in part on the benefit group identifier, a contract status of the benefit group associated with the benefit response message, wherein;
if the determination is a contracted entity status, direct communication of a provider message to the healthcare provider computer associated with the healthcare provider, the provider message including a first benefit information portion and a second benefit information portion accessible for display by the healthcare provider computer; and
if the determination is a non-contracted entity status, direct communication of a limited provider message to the healthcare provider computer associated with the healthcare provider, the limited provider message including the first benefit information portion and the second benefit information portion, wherein only the first benefit information is accessible for display by the healthcare provider computer.

12. The system of claim 11, wherein the at least one processor configured to access the at least one memory and execute the computer-executable instructions to determine the contract status of the benefit group associated with the benefit response message further comprises instructions to:
access one or more healthcare entity files;
compare the benefit group identifier to healthcare entity information in the one or more healthcare entity files; and
identify a contract status indicator in the healthcare entity information, wherein a contracted entity status has a positive designation and a non-contracted entity status has a negative designation.

13. The system of claim 12, wherein the healthcare entity information comprises at least one of a healthcare benefit group number, a pharmacy benefit manager identification number, one or more benefit group names, or routing information.

14. The system of claim 11 wherein the at least one processor is further configured to access the at least one memory and execute the computer-executable instructions to
filter the benefit response information included in the benefit response message; and
designate a first filtered portion of the benefit response information as the first benefit information portion and a second filtered portion of the benefit response information as the second benefit information portion.

15. The system of claim 14, wherein the first benefit information portion includes at least the patient co-pay amount.

16. The system of claim 14, wherein the second benefit information portion includes at least the one or more formulary alternatives.

17. The system of claim 16, wherein the second benefit information portion further includes at least one of patient general care information, additional formulary information, information associated with a prior transaction authorization, information associated with a prior transaction rejection, or one or more advertisements.

18. The system of claim 11, wherein the prescription transaction information includes at least a medication name or a medication identification.

19. The system of claim 11, wherein the benefit response message comprises medication information provided by one or more pharmaceutical manufacturers, one or more pharmaceutical suppliers, one or more governmental agencies, or one or more third party suppliers.

20. The system of claim 11, wherein the benefit group identifier is at least one of a benefit group identification number, a bank identification number (BIN) or a benefit group name.
